(19) United States
(12) Patent Application Publication
(10) Pub. No.: US 2014/0214459 A1
(43) Pub. Date: Jul. 31, 2014

(54) SYSTEM AND METHOD FOR AUTOMATED DEMAND CHARGE MANAGEMENT

(71) Applicants: Geoffrey Ryder, Menlo Park, CA (US); Timo Stelzer, Palo Alto, CA (US); Daniel Brinkmann, Walldorf (DE)

(72) Inventors: Geoffrey Ryder, Menlo Park, CA (US); Timo Stelzer, Palo Alto, CA (US); Daniel Brinkmann, Walldorf (DE)

(73) Assignee: SAP AG, Walldorf (DE)

(21) Appl. No.: 13/753,030

(22) Filed: Jan. 29, 2013

(51) Int. Cl. G06Q 30/02; G06Q 10/02

(52) U.S. Cl. CPC G06Q 30/0259; G06Q 10/02
USPC 705/5

(57) ABSTRACT

The disclosure relates to a system and method for managing demand charge tariffs for electric power, in particular, providing economic energy management for charging electric vehicles at public charge stations. The system and method may include collecting, by an infrastructure service cloud, information related to electric vehicle charging from a plurality of interested parties and calculating a particularized offer to a customer based on customer's characteristics compared to other possible customers in a same time period. The system and method may also include transmitting the particularized offer to the customer and upon receiving an acceptance of the particularized offer, reserving the charge spot for the driver.

### FIELD OF THE INVENTION

The disclosure relates to a system and method for managing demand charge tariffs for electric power, in particular, providing economic energy management for charging electric vehicles at public charge stations.

### BACKGROUND

Electric vehicles (EVs) are gaining popularity, but limitations in charging options may stunt their growth. Due to the limited range available with today's electric vehicles, electric vehicle drivers have to rely on both the ability to charge at home as well as away from home at public charging stations. However, public charging stations are not widely available and easily accessible by electric vehicle drivers.

In some communities in the United States, public charging stations are being offered through government grants to encourage electric vehicle purchases. Nevertheless, the public charging stations only have limited existence today. One barrier deterring new public charging stations installation are utility tariff structures. Typically, electricity cost for businesses are billed not only based on the total usage for each month but also on their respective peak usage during a month. For example, if a business has a peak usage exceeding a threshold level during a month, a multiplication factor larger than one will be applied to its electricity bill for the month. That is, the business will incur a higher cost for exceeding the threshold level. Thus, if a business installs public charging stations on its premises, the charging operation may cause the electricity usage by the business to exceed a peak usage threshold and force the business to pay a penalty on its electricity cost. To make the matter more complicated, if the business wants to control the charging operation at the public charging stations on its premises, any driver interested in charging at the controlled public charging stations would like to get advanced notice before they pull up to charge.

Accordingly, there is a need in the art for providing economic energy management for charging electric vehicles at public charging stations.

### BRIEF DESCRIPTION OF THE DRAWINGS

FIG. 1 is a block diagram of a system for providing economic energy management for charging electric vehicles according to an embodiment of the present invention.

FIG. 2 is a sequence diagram for providing economic energy management for charging electric vehicles according to an embodiment of the present invention.

FIG. 3 is a block diagram showing information flows of an electrical-vehicle charging management system according to an embodiment of the present invention.

FIG. 4 is a block diagram of a computer system according to embodiment of the present invention.

FIG. 5(a) illustrates a flow chart of a process for providing economic energy management for charging electric vehicles according to an embodiment of the present invention.

FIG. 5(b) illustrates customer classes according to an embodiment of the present invention.

FIG. 5(c) illustrates a power distribution graph according to an embodiment of the present invention.

FIG. 6 illustrates customer classes of expected revenue and costs according to an embodiment of the present invention.

FIG. 7 illustrates a probability distribution graph according to embodiment of the present invention.

### DETAILED DESCRIPTION

Embodiments of the present invention may provide a method for calculating a charging offer. The method may include collecting, by an infrastructure service cloud, information related to electric vehicle charging from a plurality of interested parties and calculating a particularized offer to a customer based on customer's characteristics compared to other possible customers in a same time period. The method may also include transmitting the particularized offer to the customer and upon receiving an acceptance of the particularized offer, reserving the charge spot for the driver.

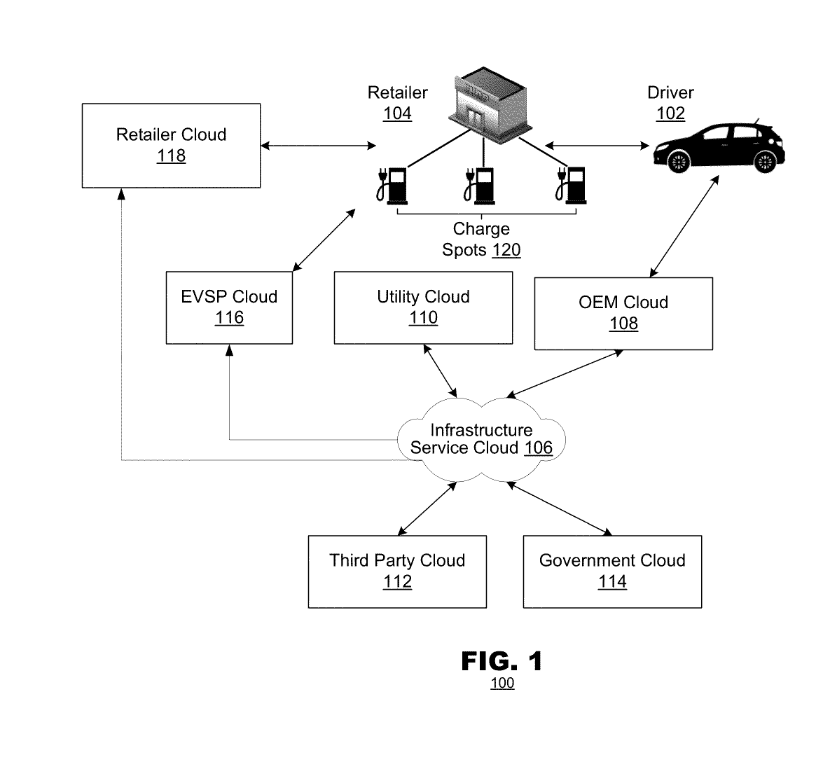

FIG. 1 illustrates a system 100 for providing economic energy management for charging electric vehicles according to an embodiment of the present invention. In the disclosure herein, charge station, charge spot and electric vehicle supply equipment (EVSE) are used interchangeably and refer to an outlet where an electric vehicle can take in power to recharge its battery. Also, the charge station's activity may be monitored through a network communication system. The system 100 may comprise a driver (D) 102 driving an electric vehicle, a retailer (R) 104 that may have a plurality of charge spots (E) 102, a retailer cloud (RC) 118, an electric vehicle service provider (EVSP) cloud (EV) 116, a utility cloud (UC) 110, an original equipment manufacture (OEM) cloud (OC) 108, a third party cloud (TPC) 112, a government cloud (GC) 114 and an infrastructure service cloud (SC) 106.

The driver 102 may represent a plurality of drivers that drive electric vehicles. The driver 102 may drive the electric vehicle around and request charging at public charge stations. The electricity to be consumed for charging the electric vehicle at a public charge station may be referred to as demand charge. The retailer 104 may be a store or franchisee that hosts public charge spots 120. The retailer 104 may represent a plurality of retailers under control by a retailer chain. The retailer cloud 118 may be a computer network for the retailer's parent organization (e.g., the retailer chain). The parent organization may partly determine policy for the retailer 104. The retailer cloud 118 may represent a plurality of retailer organizations that each may have a plurality of retailer stores like the retailer 104. Each of the charge spots 120 may be a networked charging station that may be monitored and remote-controlled. The EVSP cloud 116 may represent a network server of the EVSP that directly controls charging stations. The utility cloud 110 may represent a local utility's network computer servers. These computer servers may hold energy usage information and compute official demand charges.

The OEM cloud 108 may represent a computer network for the vehicle manufacture or the dealer of the electric vehicle driven by the driver 102. The OEM cloud 108 may communicate with the vehicle by wireless communication. In one or more embodiments, the OEM cloud 108 may comprise network servers belonging to the driver's OEM brand and the OEM may control the communication with the electric vehicle drive by the driver 102 such that all communication may go through the OC 108.

The TPC 112 may comprise a computer network of a third party that may be interested in allowing D 102 to access E 104, and may reimburse demand charges. The GC 114 may be a computer network of a government entity that may track energy supplied by E, and tax it, or issue credits for it. The SC 106 may be a cloud-based computing platform that provides services to and routes data from all the other entities. In the system 100, each of the clouds may comprise a plurality of interconnected computing devices, including, for example, computer servers, terminals, data storage devices.

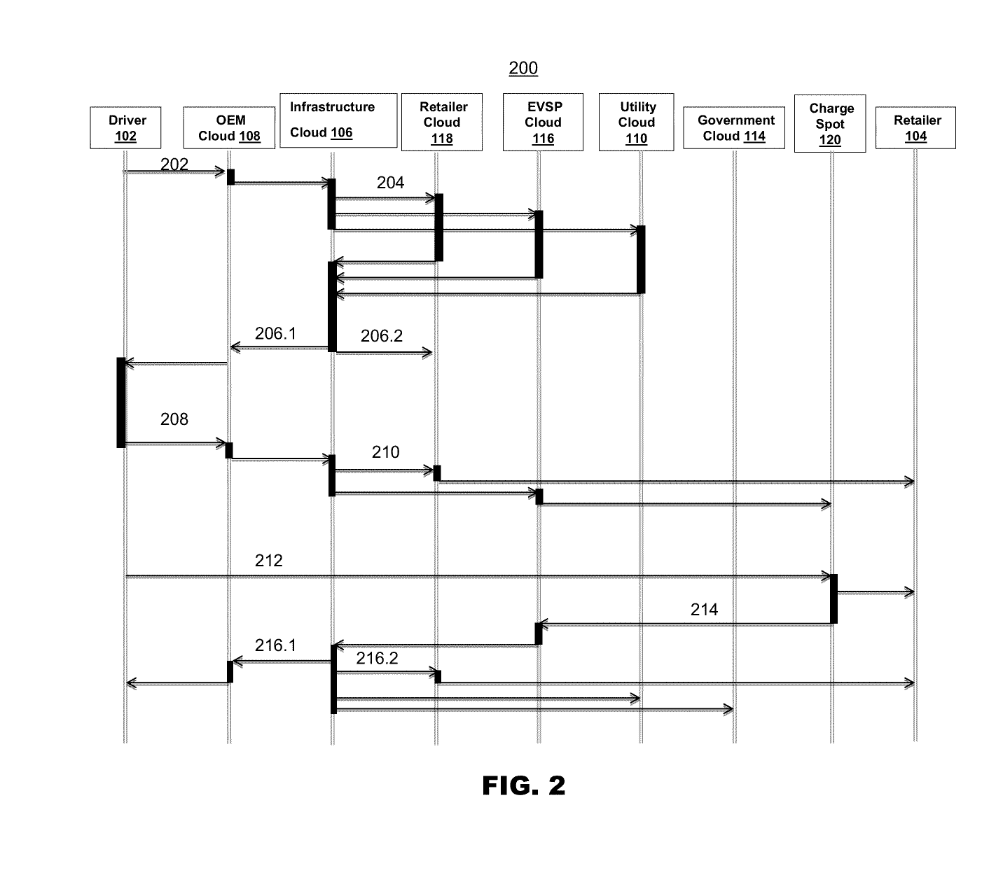

FIG. 2 illustrate a sequence 200 for providing economic energy management for charging electric vehicles according to an embodiment of the present invention. The driver 102 may wish to charge an electric vehicle at a charge spot 120 installed at the retailer 104. At 202, the driver 102 may asks for availability and price of charging at the charge spot 120. As described above with respect to FIG. 1, the request from the driver 102 may be transmitted from the electric vehicle driven by the driver 102 to the OEM cloud 108, which may forward the request to the SC 106. At 204, the SC 106 may pull information from the RC 118, EC 116 and UC 110, and compute a demand charge price (p_D). For example, the SC 106 may pull electricity price information from the UC 110, schedule information for charge spots (including information for all charge spots 120 at the retailer 104) from the EC 116, and/or customer profitability information and non-EV electricity usage for the retailer 104 from the RC 118. The profitability information may define an empirically estimated probability distribution characterizing the probability that this customer's purchases contribute a specific amount to the retailer's profit margins. Customers whose expected profitability value is high may be given more generous p_D offers by the retailer. For reference, “p” (lower case) may represent a price, “P” (upper case) may represent an amount of electric power, and “t” may represent a period of time. A generous offer may mean a higher rate of charge P_D_kW, measured in instantaneous kilowatts; a longer time duration of charge t_D, typically measured in seconds; a corresponding larger rate of total energy delivered to the vehicle during the session P_D_kWh, typically measured in kilowatt-hours; and/or bigger discounts on the store's products and services than other drivers receive. In an embodiment, p_D may represent the price in units of currency of the offer to D, and the other components of the offer may be represented as a tuple in terms of the maximum rate of charge P_kW, and time duration of charge t_D, or (p_D, P_kW_D, t_D). In an embodiment, store product and service discounts may also be taken in account as an exogenous factor incorporated in p_D. Embodiments of p_D offer calculations are described below in further detail.

At 206.1 and 206.2, the SC 106 may inform the driver 102 (via the OC 108) and RC 118 of the offer p_D. At 208, the driver 208 may send (via the OC 108) an acceptance of the offer to the SC 106. At 210, the SC 106 may reserve the charge spot 120 at the EC 116, which may send a reservation notice to the charge spot 120. Also, the SC 106 may notify the RC 118, which may in turn notify the retailer 104 that a charge spot 120 at the retailer 104 has been reserved. At 212, the driver 102 may charge the electric vehicle at the charge spot 120 while going into the retailer 104 to purchase goods or services. At 214, the charge spot 120 may report the charging session ended to the EC 116, which may report to the SC 106. At 216.1, the SC 106 may notify the driver 102 (via the OC 108) of the final duration and price of the charging event. And at 216.2, the SC 106 may notify other parties (e.g., the UC 110, GC 114, RC 118 and the retailer 104) of the event, for their records. In one embodiment, the driver may be receive a financial charge that may be consolidated into a monthly bill.

In one or more embodiments, the sequence 200 may cover back-end interactions among the parties shown in the system 100 of FIG. 1 in order to allow charging. At the same time, the system 100 may use the sequence 200 to accomplish other goals: (a) avoiding increased demand charges in the retailer 104's utility bill, and/or (b) allowing interested third parties to compensate the retailer 104 for the demand charges incurred. The system 100 may provide connection to multiple parties through the SC 106's cloud service. The sequence 200 may facilitate information flows to inform the driver and all interested parties to coordinate optimal activity. The SC 106 may include analytics engines to compute optimal policies for all the parties.

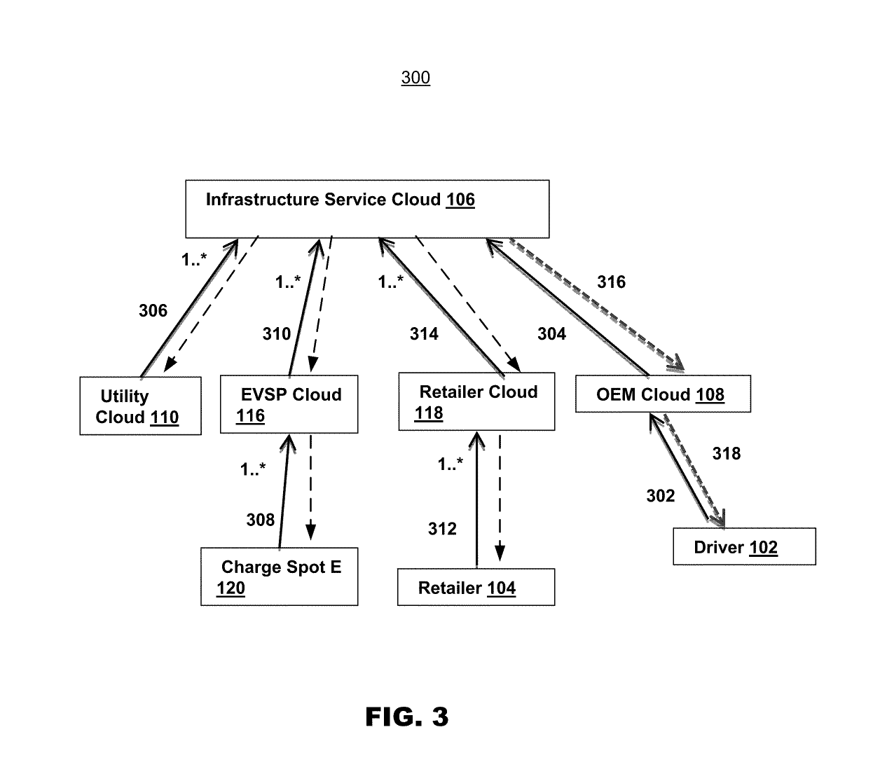

FIG. 3 is a block diagram showing information flows of the system 100 according to an embodiment of the present invention. As shown in FIG. 3, the arrow 302 may indicate the driver 102 may send information to the OEM cloud 108. For example, the driver 102 may request reservation of a charge spot when driving through a neighborhood and request for p_D offers to choose from. The request may be forwarded by the OEM cloud 108 to the infrastructure service cloud 106 as indicated by the arrow 304.

The infrastructure service cloud 106 may collect information from the utility cloud 110 as indicated by the arrow 306, from the ESVP cloud 116 as indicated by the arrow 310 and from the retailer cloud 118 as indicated by the arrow 314. For example, the infrastructure service cloud 106 may collect electricity prices from a plurality of utilities via one or more utility cloud 110. In an embodiment, the infrastructure service cloud 106 may collect other information related to power usage from the utility cloud such as maximum instantaneous peak power in a month (P) (typically in kW), a threshold level of P below which high demand charges are not incurred by the retailer (P*), a range of “safe” values of P so as to avoid high charges by the retailer (P0), a range of P values where high demand charges are incurred by the retailer (P1), power used in a time period (pₖ), and cost per time (cₖ). Based on pₖ and cₖ, the retailer's cumulative cost of energy over a specific time period (C) may be expressed as:

C=Σₖ₌₀^{K}pₖ*cₖ

In an embodiment, C may be calculated at the utility cloud 110 and transmitted to the infrastructure service cloud 106, or, alternatively, C may be calculated at the infrastructure service cloud 106.

Moreover, the utility cloud 110 may provide values m and n, from which a demand charge multiplier (Mₚ) may be calculated by the infrastructure service cloud 106, expressed as:

$${M}_{p} = \frac{m \%}{n ( kWh )} * ( P - {P}^{*} \vert P > {P}^{*} )$$

where Mₚ may be a unitless percentage. As the above equation illustrates, Mₚ may be based on P such that P is greater than P*. From Mₚ, a demand charge constant K_{d} may be calculated that determines the effect of the demand charge on the electricity price for the retailer. K_{d}, which may be referred to as a intermediate variable, may be expressed as:

K_{d}=1.0+Mₚ

The total energy cost for the retailer (Cₜₒₜ) may be a factor of cumulative cost of energy (C) over a specific time period and the demand charge constant K_{d}, and may then be expressed as:

Cₜₒₜ=K_{d}*C

Further, the infrastructure service cloud 106 may collect scheduling information for charge spots in the neighborhood from an EV service provider via the ESVP cloud 116. Each ESVP cloud 116 may check availability of all charge spots E 120 under its control (e.g., busy or free, are there reservations, etc.). For example, EVSP cloud 116 may provide times available for reservation (tᵣₑₛ) from a master calendar to the infrastructure service cloud 106.

The retailer cloud 118 may collect non-EV electricity usage information from the retailer 104, for example, by the arrow 312. The infrastructure service cloud 106 may check customer profitability and non-EV electricity usage of the retailer 104 via the retailer cloud 118. In an embodiment, the retailer 104 via the retailer cloud 118 may provide information such as power used by the retailer 104 for things other than EVSE (P/e). Based on available information, infrastructure service cloud 106 and/or retailer cloud 188 may calculate an expected value of P (EP), an expected value of profitability (EV), and forecast value of the total cost of energy in time period (EC). In an embodiment, the time period may be a month, a week, a year, etc. EC may be a statistical forecast of an expected value and may be expressed as:

EC=Σₖ₌₀^{K}E(pₖ*cₖ)

In an embodiment, the infrastructure service cloud 106 may compute one or more p_D offers based on the collected information and calculated values described above as will discussed in further detail below The information collected by the infrastructure service cloud 106's may be pulled by the infrastructure service cloud 106 and/or pushed from the utility cloud 110, the ESVP cloud 116 and the retailer cloud 118.

After computing one or more offers of p_D, the infrastructure service cloud 106 may send the offer(s) to the OEM cloud 108, e.g., as indicated by the arrow 316. The OEM cloud 108 may relay offer(s) to the vehicle and driver 102, e.g., as indicated by the information flow arrow 308.

In one embodiment, the information collection, p_D computation, request and response processes may be fully automated. For example, when the electric vehicle enters a neighborhood, the location information may be pushed from the vehicle to the infrastructure service cloud 106 via the OEM cloud 108. The infrastructure service cloud 106 may compute a plurality of p_D offers and then automatically choose one for the driver.

In one embodiment, a store may use location based (LBS) data from OC to tweak its offers, for example, set aside p_D, and make preferential p_D offers to VIPs that are passing by. In one embodiment, a store may use location-based data from OC to know that certain drivers are nearby, and then match those drivers' identities with the store's collected customer profitability data. After doing the matching the retailer may know the expected profitability value of these nearby drivers, and make the most generous offers in real time to the most profitable drivers among them as they approach the store. The retailer may choose to let properly constrained automated p_D computations generate the p_D offers most of the time, without manual intervention.

In an embodiment, automatic calculations may be supplemented with manual processing. For example, an inoperable vehicle or a fallen tree may temporarily block access to charging stations in a way that is visible to the store manager, but may not be captured by automated sensors. In such a case the store manager may manually stop p_D offers for the blocked stations from being sent. Or, a data processing error, based on faulty data, may grossly overestimate or underestimate the profitability of a given customer, in a way that is obvious to the store manager, requiring a manual adjustment of the p_D offer.

Each arrow in FIG. 3 labeled “1 . . . *” may designate a many to one relation along the direction of the arrow. Thus, the infrastructure service cloud 106 may collect information from more than one utility cloud 110, more than one EC 116, and/or more than one RC 118. That is, more than one utility companies, more than one EV service providers, more than one retail organizations may be used to provide a best offer p_D to the driver in the neighborhood.

In one embodiment, manual operation may be needed by the driver 102 and a store manager at the retailer 104 to complete a transaction. In one embodiment, multiple p_D offers may be provided to D. Those p_D offers may be relevant to the driver 102's trip and destination, and the driver 102 may select the one that best fits his/her need.

In one embodiment, the driver 102 may set a control that allows the OC 108 to provide the vehicle's location to nearby stores, and continually collects p_D offers from multiple retailers within a convenient distance. That, is each store may generate responsive p_D offers to present to the driver 102 as the driver 102 passes by (e.g., after looking up the driver 102's value as a customer in the retailer cloud 118).

In one embodiment, the infrastructure service cloud 106 as shown in FIG. 3 may handle multiple drivers; and even multiple OEM Clouds handling requests and offers from multiple drivers from different OEM clouds. In this embodiment, the UI for a store manager at the retailer 104 may organize and present all that information from many different OEM's drivers to the store manage to decide how to make p_D offers to different drivers.

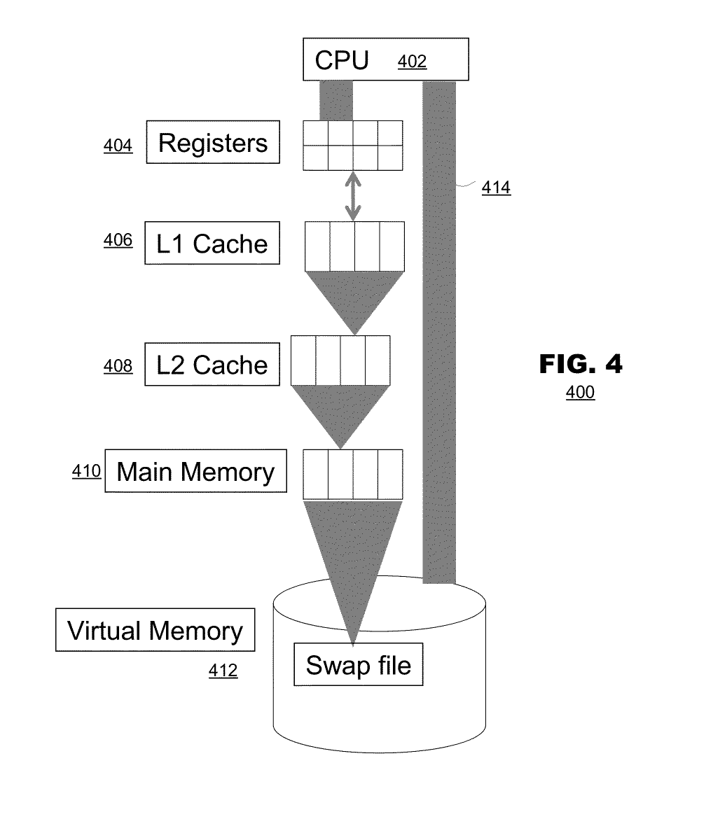

FIG. 4 illustrates an exemplary computer system 400 according to an embodiment of the present invention. For example, the computer system 400 may be provided in the infrastructure service cloud 106 to perform the calculations described herein. The computer system 400 may include a central processing unit (CPU), registers 404, L1 cache 406, L2 cache 407, a main memory 410, a virtual memory 412, and a bus 414.

The CPU may be provided on a CPU die and may include the registers 404, which may be used for executing program instructions such as interrupts or the like. The CPU 410 may be provided as a programmable processor that executes instructions residing in memory to receive and send data via the I/O device(s) (not shown). The instructions may provide economic energy management for charging electric vehicles at public charging stations as described herein. The term programmable processor as used herein may refer to any programmable microprocessor or processor or combination of microprocessors or processors that can operate on digital data, which may be special or general purpose processors coupled to receive data and instructions from, and to transmit data and instructions to, a machine-readable medium.

The computer system 400 may include a variety of storage locations for data such as the L1 cache 406, the L2 cache 408, the main memory 410, and the virtual memory 412, which may include disk drives. The storage locations may be coupled to the CPU 402 via the bus 414.

Embodiments of the present invention may utilize in-memory database (IMDB) calculation techniques. In IMDB, all relevant data resides in main memory (say, main memory 410). Thus, calculation/computation speed may be significantly increased as compared to conventional systems where data is stored in relational databases away from the main memory, for example on disk.

Numerical quantities described herein for computation may be stored logically in database columns in neighboring sections of the main memory 410. This arrangement may allow the CPU 402 to perform calculations/computations relatively fast on entire database columns as compared to conventional systems that store numerical quantities in rows. For example, cache misses may be reduced when searching on data organized in column form than in row form. In an embodiment, multiple CPUs may be performing calculations on data residing in the same memory space.

Also, the numerical quantities and/or other data stored as columns may be compressed by a run-length-encoding technique algorithm. Contents of neighboring memory blocks may be of the same data type and often values may repeat; therefore, compression may increase the amount of data stored in the main memory 410.

In an embodiment, the computer system 400 may be provided to be compatible with functions allowing row based access to data as well as column based. Hence, the computer system 400 may be backward compatible to other database systems including existing systems.

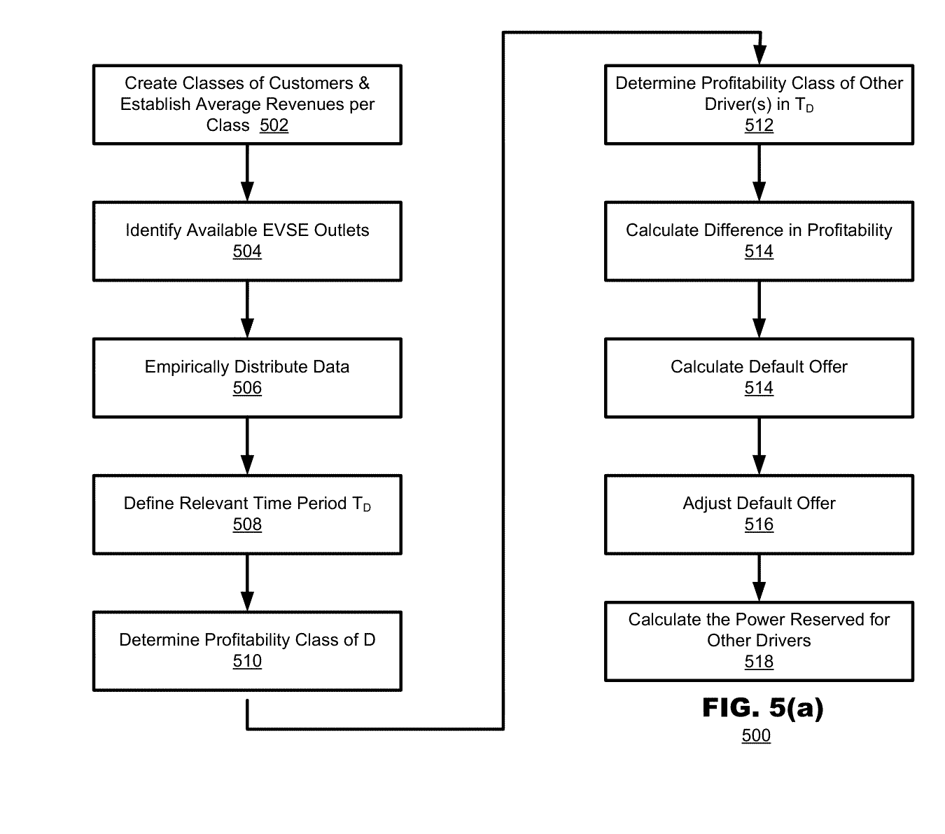

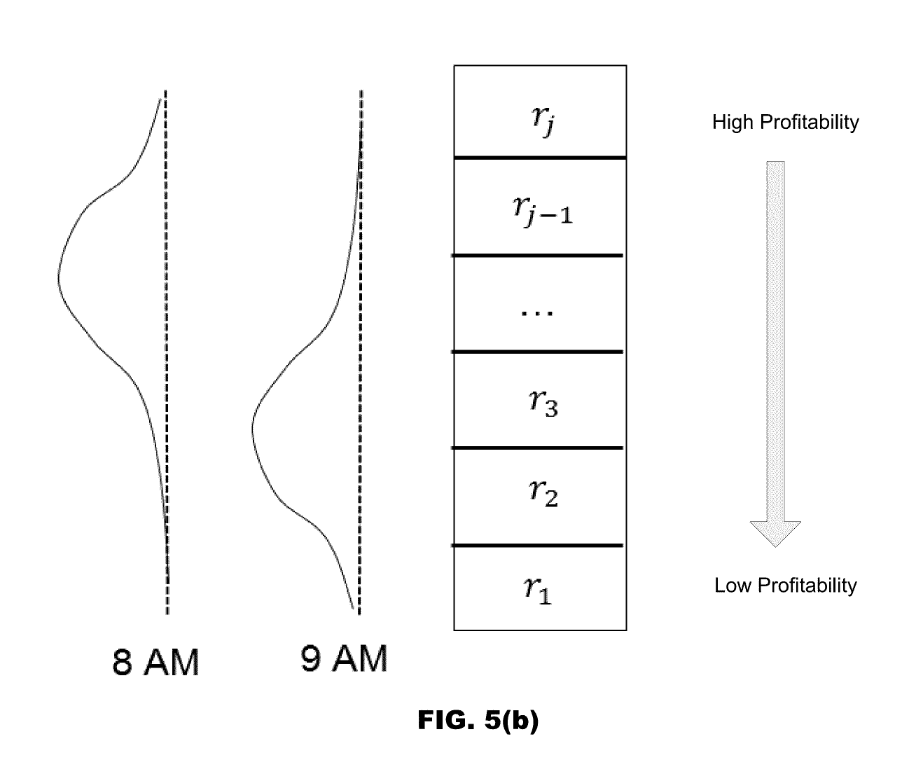

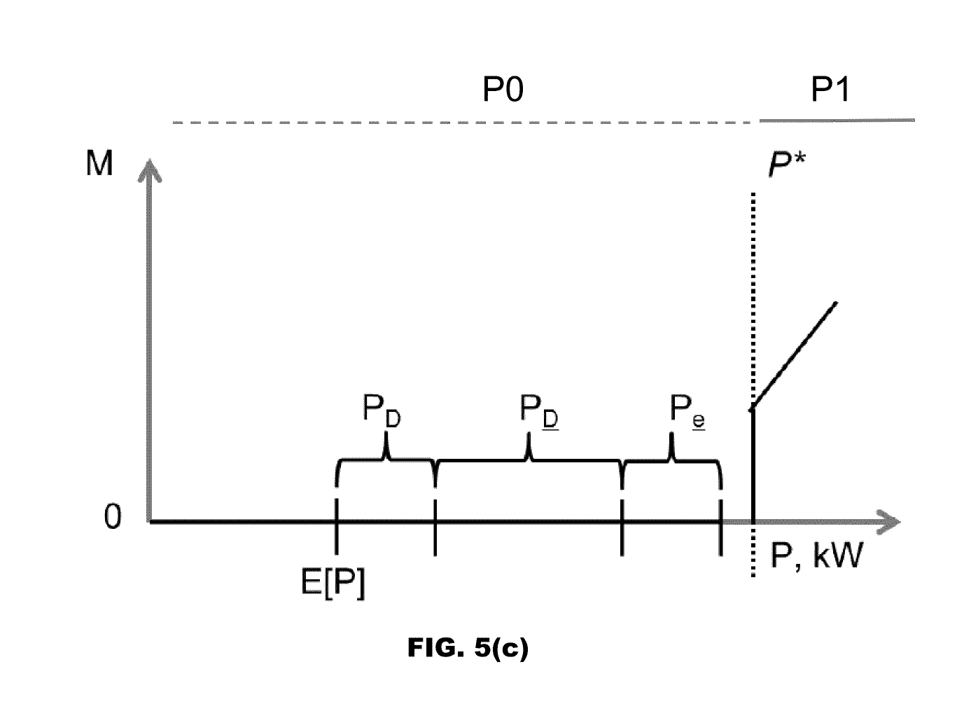

FIG. 5(a) illustrates an offer calculation process 500 according to an embodiment of the present invention. In an embodiment, the offer calculation process 500 may be executed by the infrastructure service cloud 106 using IMDB techniques. In step 502, classes of customers may be created. The customer classes may be created by k-means or other suitable clustering algorithms. Also, average revenues for each customer class may be established. For example, average revenue per unit time spent in the retailer for each customer class my be established. FIG. 5(b) illustrates an exemplary graph showing r1-rj customer classes arranged in accordance with their profitability level in different time periods. In this example, rj is shown as the highest profitable customer class while r1 is shown as the lowest profitable customer class. Furthermore, the distribution of customers by profitability class may vary over time. In this example, high-spending customers arrive in the 8 am hour (say, before work), and in the 9 am hour the clientele shift to lower-spending customers (say, bargain hunters).

Returning to FIG. 5(a), available EVSE outlets at the retailer may be identified in step 504. The same retailer may offer different maximum power outlets. For example, a retailer may offer different EVSE outlets with maximum power of 1 kW, 3 kW, 6 kW, etc.

In step 506, the number of customers N that arrive at a certain time period (e.g., in an hour interval) may be empirically distributed. In an embodiment, the data may be distributed at one hour intervals for the day. The empirical distribution may be based on predictive data such as the expected number of customers (EN) that arrive in the time period. The expected number may be based on past patterns from other similar days.

In step 508, a relevant time period t_D may be defined for when D is expected to arrive at the retailer. In an embodiment, this value may be calculated based on information collected from D such as GPS location, speed, distance from retailer, traffic, etc. In another embodiment, D may select a time period to visit the retailer.

In step 510, the profitability customer class of D, r_D, may be determined for t_D. Driver D's customer class classification may vary by time period. For example, customers may buy more at certain times of the year or at certain hours of the day. The profitability class determination may be based on past behavior of the specific D or other similar customers. In step 512, the profitability class(es) of other driver(s), E[r_{—other}], in the other, same time period T_{D} may be determined. Again, the profitability class determination may be based on past behavior of the other drivers or other similarly situated drivers. In step 514, the difference in profitability between the driver and other drivers arriving in the same time period t_D may be calculated, which may be expressed as:

Δr=r_{D}−E[rₒₜₕₑᵣ]

In step 514, a default offer (p_avg) for all drivers in time period t_D may be calculated. Offer p_avg may be calculated based on the information collected from the utility cloud, the EVSP cloud, the retailer cloud, and/or the OEM cloud and based on other constraints calculated from the information as described above.

In an embodiment, the default offer p_avg may be calculated continuously or periodically over time because default offer factors may change over time. For example, p_avg may incorporate specific offers (p_D) to drivers and the results of those offers (accepted or rejected) in updated estimates of p_avg, P_KW_avg, and t_avg taking into account cumulative distributions for acceptance probabilities. In an embodiment where the offer is a tuple of three values (p_D, P_kW_D, t_D), a corresponding default offer benchmarks may be used of three values ((p_avg, P_kW_avg, t_avg). The benchmark values may be calculated for each time period and customer revenue category r.

In an embodiment, the benchmark tuple value calculations may begin with the calculation of the value t_avg. The average time a patron or customer is expected to spend at the retail establishment may be represented as time_in_store. This time may be adjusted if needed to equal the smallest value that could be meaningful to a driver. For example, suppose the average time spent in a particular retail establishment is 15 minutes, but most drivers indicate that they want at least six or seven miles worth of electric charge, which would typically correspond to about 30 minutes at the charging station. Thus, the value of t_avg may be adjusted to 30 minutes with 15 minutes spend in the retail establishment.

Next, the value P_kW_avg may be calculated. The P_kW_avg may be based on the number of charge spots and the power level that triggers the high demand charge (exceed P*). For example, consider charge spots i, where i is more than 1 but less than the number of charge spots on the particular premises (N_cs), are used at each ones' full rated capacity, P_max_i. Thus, an initial estimate for the power taken by all N_cs charge spots may be expressed as:

P_max=Σᵢ₋₁^{N}^{_{—}}^{cs}P_max_{—}i

Now if there is excess capacity between instantaneous power allocated for electric vehicle charging and the instantaneous power level P* that triggers high demand charges (as in FIG. 5(c)), then the power allocated to electric vehicle charging may be expressed as:

P_all_EV=P*−P_{—}/e

where P_/e represents power for other uses. If running all charge spots at full capacity will incur high demand charges (P_max>P_all_EV), then P_max_i may be reduced by a value Δ_i until high demand charges will not be incurred. The value Δ_i may be selected by equal amounts or proportional to their capacity or some other capacity rationing method for each charge spot i. The adjustment for Δ_i may be expressed as:

P_max=Σᵢ₌₁^{N}^{_{—}}^{cs}(P_max_{—}i−Δ_{—}i)≦P*−P_{—}/e

Thus, P_kW_avg may be represented by the mean and may be expressed as:

$$P\_kW \_avg = \frac{P\_all \_EV}{N\_cs}$$

Again p_avg is the default price. Cost may also be factored into the default price. For example, cost of energy, c_k, for the utility's defined time period of interest which may overlap but may differ from the revenue segmentation and time segmentation discussed above. Another cost factor may be exogenous costs, c_ex, that include costs besides energy related to charging service to an EV. Therefore, the default price may be expressed as:

p_avg=c_{—}k*P_kW_avg*t_avg+c_{—}ex

Returning to FIG. 5(a) in step 516, the default offer may be adjusted for D according to the D's profitability as compared to other drivers to provide the offer p_D. In an embodiment, the adjusted offer may be expressed as:

p_{—}D=p_avg+Δr

where p_avg is the default offer and Δr is the difference in profitability. For example, customers whose expected profitability value is high may be given more generous p_D offers. A generous offer may mean a higher rate of charge, a longer time duration of charge, and/or bigger discounts on the store's products and services than other drivers receive.

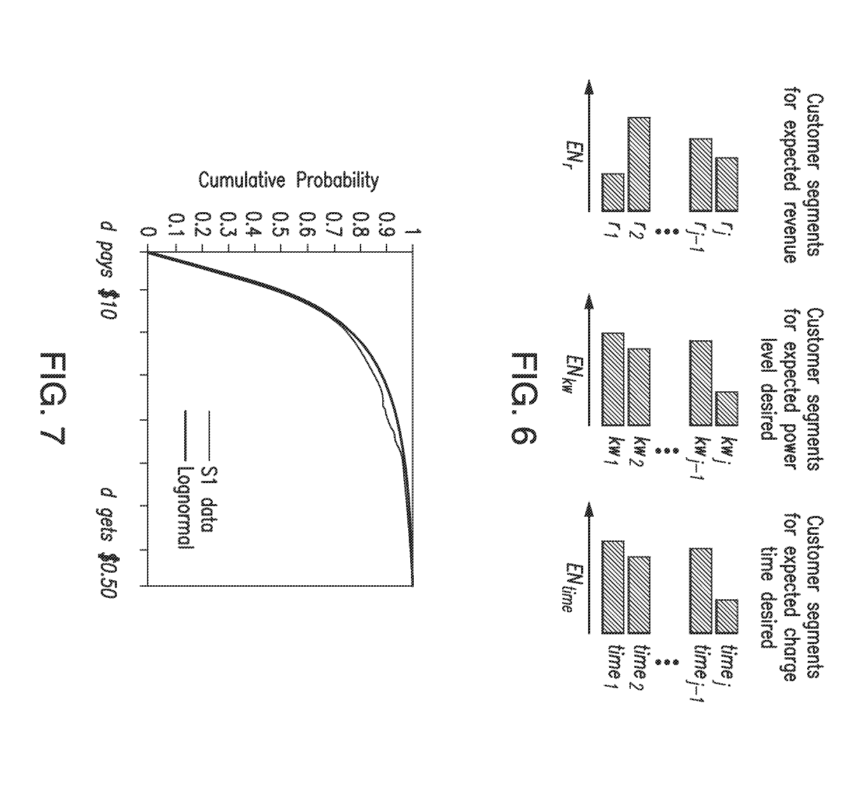

In an embodiment, the offer p_D may be automated and may be based on the difference between expected revenue and expected cost particular to the driver and also the difference between the expected revenue and expected cost for average driver at the same time period (i.e., default). As discussed above, based on the estimated time of arrival for the driver and using statistical routines, predictive customer segmentation may be executed for the expected drivers that will be present at the time of arrival for the driver. FIG. 6 illustrates exemplary predictive customer segmentation as depicted by discrete empirical distributions of expected revenue and costs, where expected costs can be calculated as expected power level desired and expected charge time desired. Value r_j may correspond to the highest expected revenue customer segment and r_{—}1 may correspond to the lowest expected revenue customer segment. Value kW_j may correspond to the highest expected power level cost customer segment and kW_{—}1 may correspond to the lowest expected power level cost customer segment. Time t_j may correspond to the highest expected time cost customer segment and time t_{—}1 may correspond to the lowest expected time cost customer segment. Expected value EN is the expected number for each customer segment.

In an embodiment, the predictive customer segmentation may be adjusted based on environmental variables such as seasonal factors and time of day. The distribution may be computed for each defined time period, which may, for example, vary from a few minutes to several hour(s), depending on the capacity of the EVSE.

Based on the cost estimates, the cost of providing services to the driver D may be calculated. In an embodiment, the costs of providing services to the driver D may be adjusted for the difference between the value of the driver D and the hypothetical average customer (default). Hence, the cost of providing services to the driver may be the sum of the costs of energy requested by the driver plus the cost of denying that energy to another customer plus the cost of denying parking to another customer (time variable).

The hypothetical average driver may have a revenue factor of r_avg, a power level cost factor of P_kW_avg, and a time cost of time, and the driver may have a particularized revenue factor of r_D, a particularized power level cost factor P_kW_D, and a particularized time cost of t_D. Thus, the costs particular to the driver may be the difference between the costs of the hypothetical average driver and the particularized costs of the driver.

Also, a probability distribution (CDF_D) that models the likelihood that driver D accepts an offer may be calculated. The probability distribution may be based on recent transactions with drivers. FIG. 7 is an exemplary probability distribution (CDF_D) according to an embodiment of the present invention. As shown in FIG. 7, the higher the offer the less likely the driver will accept the offer and the lower the offer (or possibly a reimbursement as shown), the likelier the driver will accept the offer. For illustration this is a simplified CDF taken only with respect to offer price p_D, but as the rate of power and length of charge time also vary, in general the CDF may be a threefold convolution of random variables p_D, P_kW_D, and t_D.

The offer p_D may then be computed by maximizing the relationship of the probability of the driver accepting the offer in conjunction with the profit associated with that driver (difference of revenue and cost) and the probability of the driver not accepting the offer in conjunction with the profit associated with the hypothetical average driver.

The calculation of p_D may depend on information drawn together from the various parties of FIGS. 1 and 3, and may be calculated in real time through the IMDB calculation described herein in various embodiments. The calculation may be in the form of an optimization of the retailer's objective function Z that depends on p_D, Z(p_D), and that contains relevant revenue and/or cost terms. The following objection function may be maximized with respect to (p_D, P_kW_D, t_D) and by varying (p_D, P_kW_D, t_D):

Z(p_{—}D)=CDF_{—}d(p_{—}D, P_kW_{—}D, time_{—}D)*[r_{—}D+p_{—}D−c_{—}D]+(1−CDF_{—}d(p_{—}D, P_kW_{—}D, time_{—}D))*(1−p_zero)*[r_avg+p_avg−c_avg]

where p_avg is the average offer that the retailer gives to drivers of this revenue class and time period, considering season and time of day; r_avg is the expected revenue from the average driver, predicted for time period t_D; c_avg=expected cost from the average driver, predicted for time period t_D; c_D is the expected cost from driver D, predicted for time period t_D; and p_zero is the probability that no other driver is interested in time period t_D. The above objective function may be maximized such that exogenous constraints appropriate to each quantity in the objective function are met. By business arrangements among the parties or other means, these constraints may be known to the service cloud 106.

Further, the above objective function is the sum of two mutually exclusive events −D accepting the offer and D not accepting the offer. Thus, the total probability of CDF(p_D,P_kW_D,t_D)+(1−CDF(p_D,P_kW_D,t_D))=1. Also, through probability p_zero, the above objective function may take into account that no drivers except D may be interested in charging at time t_D. Other costs of operation and serving customers may also be incorporated in r_D and r_avg.

The cost, c_D, may be formed by two elements: c_D_kWh, which is the total cost of all the energy used by the driver, and c_D_kW, which is the additional cost from demand charges due to the peak amount of power that D will draw during the charging session. P_over, which is the amount of peak power P that the retail establishment exceeds P*, may be expressed as:

P_over=(P−P*|P>P*)

Thus, P_over is zero if P<P*. The power distribution and offers may be calculated to keep the retailer below the threshold of higher demand charges. FIG. 5(c) is an exemplary graph illustrating the power distribution relationships. P* is the maximum value of P below which the retailer is not charged at a higher premium. In FIG. 5(c), a retailer in region P0 incurs no demand charges, but in region P1 it does incur demand charges. The retailer, however, may choose to operate in region P1, given sufficient revenue from electric vehicle drivers will offset the higher demand charges incurred.

P_kW_D for driver D may be divided into two parts as well: a part that contributes to demand charges, P_D_P1, and a part that does not, P_D_P0. Thus, the power cost associated with the driver may be expressed as:

c_{—}D_kw=P_{—}D_{—}P1*[1+(m/n)}*c_{—}k

where c_k is the retail location's energy cost during the time period t_D provided by the utility cloud 110, and m and n are values provided by the utility Cloud 110. These values may be dynamic and may depend on the time of use. Therefore, the estimated total cost of energy may be expressed as:

c_{—}D_kWh=[c_{—}D_kw+(P_{—}D_{—}P0*c_{—}k)]*t_{—}D

Note that the offer p_D may establish a new peak demand charge for the month, affecting the retailer's bill for the entire month, so the calculation may produce a large increase in cost at this step. In addition, P_D_P1, P_D_P0, and c_k may be each be lowered by participation in a demand response program, which may also be coordinated as a communication from utility cloud 110 to service cloud 106, and from service cloud 106 to OC 108, utility cloud 110, EV 116, RC 118, R 104, D 102, and public charge spots 120 as shown in FIG. 1.

Returning to FIG. 5(a) in step 518, power reserved for the other drivers in the time period T_{D} may be calculated. The power reserved for other drivers POD may be expressed as:

P_{—}OD=EN*P_kW_avg−P_kW_{—}D

where EN is the expected number of drivers, P_kW_avg is the default offer, and P_kW_D is the offer to D.

After the calculations in process 500 of FIG. 5(a) are performed, the offer p_D may be transmitted to driver D. Also, offer(s) to other driver(s) may also be transmitted. In an embodiment, Z(p_D) may be adjusted to be a multivariable optimization problem with Z(p_D_n), and p_D_n will be a vector of offers for multiple drivers in time period t_D. Therefore, by having specific and particularized offer calculation for each driver, the process 500 optimizes profits and power usage.

In an embodiment, the infrastructure service cloud SC 106 may determine the economic impact of demand charges on the retailer R 104, the retail management's economic preferences and policies for operating its charging stations E 102, and all the methods and results described for generating the offer made to each driver, (p_D,P_kW_D,t_D). For example, the SC 106 may execute a control program that communicates with a building energy management system running at R in real time to complete a closed-loop control system whereby the actual power delivered to each driver's vehicle is managed based on the determined economic impact.

It should be understood that there exist implementations of other variations and modifications of the invention and its various aspects, as may be readily apparent to those of ordinary skill in the art, and that the invention is not limited by specific embodiments described herein. Features and embodiments described above may be combined with and without each other. It is therefore contemplated to cover any and all modifications, variations, combinations or equivalents that fall within the scope of the basic underlying principals disclosed and claimed herein.

What is claimed is:

1. A method for calculating a charging offer, comprising:
collecting, by an infrastructure service cloud, information related to electric vehicle charging from a plurality of interested parties;
calculating a particularized offer to a customer based on the customer's characteristics compared to other possible customers in a same time period;
transmitting the particularized offer to the customer;
upon receiving an acceptance of the particularized offer, reserving the charge spot for the driver.

2. The method of claim 1, wherein the interested parties include at least one from a group consisting of utility companies, retailer chains, and electric vehicle service providers.

3. The method of claim 1, wherein a profitability level of the customer is calculated and compared to profitability levels of other possible customers in the same time period.

4. The method of claim 1, wherein the particularized offer calculation is also based on demand charges of electricity usage by the charge spot.

5. The method of claim 1, wherein the particularized offer calculation is also based on the probability of the customer accepting the offer.

6. The method of claim 1, wherein the particularized offer calculation is performed using in-memory database (IMDB) calculations.

7. The method of claim 1, wherein the particularized offer is pushed to the customer when the customer drives by a designated spot without requesting an offer.

8. A non-transitory machine-readable medium storing instructions adapted to be executed by a computer to perform a method comprising:
collecting information related to electric vehicle charging from a plurality of interested parties;
calculating a particularized offer to a customer based on the customer's characteristics compared to other possible customers in a same time period;
transmitting the particularized offer to the customer;
upon receiving an acceptance of the particularized offer, reserving the charge spot for the driver.

9. The non-transitory machine-readable medium of claim 8, wherein the interested parties include at least one from a group consisting of utility companies, retailer chains, and electric vehicle service providers.

10. The non-transitory machine-readable medium of claim 8, wherein a profitability level of the customer is calculated and compared to profitability levels of other possible customers in the same time period.

11. The non-transitory machine-readable medium of claim 8, wherein the particularized offer calculation is also based on demand charges of electricity usage by the charge spot.

12. The non-transitory machine-readable medium of claim 8, wherein the particularized offer calculation is also based on the probability of the customer accepting the offer.

13. The non-transitory machine-readable medium of claim 8, wherein the particularized offer calculation is performed using in-memory database (IMDB) calculations.

14. The non-transitory machine-readable medium of claim 8, wherein the particularized offer is pushed to the customer when the customer drives by a designated spot without requesting an offer.

15. A system, comprising:
a memory to store computer program instructions; and
a processor coupled to the memory to execute the computer program instructions to:
collect information related to electric vehicle charging from a plurality of interested parties;
calculate a particularized offer to a customer based on the customer's characteristics compared to other possible customers in a same time period;
transmit the particularized offer to the customer;
upon receiving an acceptance of the particularized offer, reserve the charge spot for the driver.

16. The system of claim 15, wherein the interested parties include at least one from a group consisting of utility companies, retailer chains, and electric vehicle service providers.

17. The system of claim 15, wherein a profitability level of the customer is calculated and compared to profitability levels of other possible customers in the same time period.

18. The system of claim 15, wherein the particularized offer calculation is also based on demand charges of electricity usage by the charge spot.

19. The system of claim 15, wherein the particularized offer calculation is also based on the probability of the customer accepting the offer.

20. The system of claim 15, wherein the particularized offer calculation is performed using in-memory database (IMDB) calculations.
